(19) United States
(12) Patent Application Publication
(10) Pub. No.: US 2012/0022983 A1
(43) Pub. Date: Jan. 26, 2012

(54) Web Based Tax Preparation

(76) Inventor: Terrell D. Hughes, JR., Franklin, TN (US)

(21) Appl. No.: 12/841,666

(22) Filed: Jul. 22, 2010

(51) Int. Cl. G06F 19/00

(52) U.S. Cl. 705/31

(57) ABSTRACT

A web based tax preparation system may enable communication between an individual and a tax preparer by way of a kiosk or personal computer. The individual scans tax documents and checks the clarity of the scanned tax documents. Thereafter, the scanned and checked tax documents are transmitted to a tax preparer or made available to the tax preparer at which time the tax preparer and the individual are connected by way of a web conference. The tax preparer and the individual may simultaneously view the scanned tax documents as well as the tax return being prepared for the individual. This process streamlines the tax preparation process and also allows the individual to prepare his/her tax returns in the comfort of his/her own home as well as a kiosk which is less intimidating than making a personal appointment with a professional tax preparer.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a tax preparation system.

An individual who desires to prepare his/her tax returns may do so in one of a variety of ways. The relevant tax return documents may be downloaded and printed from the Internal Revenue Service's website, filled out and mailed back. However, since the tax code is very complex, many individuals require assistance. By way of example and not limitation, individuals may seek professional assistance from an enrolled agent or a Certified Public Accountant (CPA) that is authorized to assist the individual in preparing his/her tax returns. To this end, the individual must schedule a personal appointment with the enrolled agent or CPA. The individual must visit the enrolled agent or CPA personally and provide the tax documents to the enrolled agent or CPA. Unfortunately, this process is time consuming and may also be intimidating for certain individuals. The individual may not have all of the backup documents for the tax preparer to complete the individual's tax return. Another appointment may be necessary. Immobile individuals (e.g., bed ridden, handicapped, etc.) may also be unable to personally meet the enrolled agent or CPA. Individuals without transportation or individuals having difficulty in arranging transportation may also be unable to personally visit the enrolled agent or CPA.

Alternatively, the individual may purchase software that can be loaded on his/her personal computer to assist them in preparing his/her tax return. Inevitably, the individual will have questions regarding one or more parts of the tax return. To resolve the questions, the individual may seek help from a help desk or a forum provided by the manufacturer of the software. The help desk and forum is separate and apart from the preparation of the tax return. Accordingly, the individual must reenter or explain in detail his/her situation in order to properly ask the tax question. Accordingly, this process is cumbersome and ineffective.

Based on the foregoing discussion, there is a need in the art for an improved tax preparation system.

### BRIEF SUMMARY

The web based tax preparation system disclosed herein addresses the needs discussed above, discussed below and those that are known in the art. The system contemplates a kiosk and online embodiments for tax preparation. The kiosk may be located at a store lobby or at any location where an internet connection exists. An individual may utilize the kiosk or go to a tax preparation website (e.g., www.trxfinancial.com) and start the tax preparation process. After the basic tax documents are gathered, scanned, its clarity confirmed and transmitted to the tax preparer, the individual is then connected to the tax preparer (i.e., enrolled agent or CPA). This streamlines the tax preparer's time and also provides personal assistance to the individual at a cost effective rate. Whether the individual utilizes the kiosk embodiment or the online embodiment, the individual may be aided by a live tax preparer during the process of filling out the individual's tax returns.

To start, the individual is asked to gather specific forms (i.e., backup documents, W-2, 1099, etc.) that will be necessary to properly prepare the individual's tax return. Once the individual gathers the documents, these documents are scanned with a built in scanner on the kiosk or scanned in with the individual's home scanner. The scanned documents are checked and confirmed for clarity by the individual. The individual then enters in his/her personal information to set up an account.

After the documents are gathered, scanned and transmitted to the tax preparer or made available to the tax preparer, the individual is now connected to the live tax preparer through an electronic conferencing system (e.g., web conferencing). The tax preparer may prepare the tax documents for the individual in real time. Simultaneously, the individual may check the accuracy of the information being inputted into the tax document. Alternatively, the individual may fill out the tax documents at the kiosk or online at home with the assistance of the live tax preparer. It is contemplated that both the individual and tax preparer may simultaneously have access to the individual's tax documents and tax return during the consultation. Upon completion, the tax return may be emailed or mailed to the individual for his/her signature. Login information can be transmitted to the individual so that the individual can check status of any refund, if due.

One of the benefits of the web based tax preparation system disclosed herein is that the individual can prepare his/her tax documents with the aid of a generally inexpensive tax preparation software and the aid of a live tax preparer in real time (i.e., while the tax documents are being prepared), all at a cost effective rate and time efficient manner. Also, the tax preparer's time is not wasted since the tax preparer is not involved with the process of gathering tax documents and scanning. The individual can also have his/her tax documents prepared in the comfort of his/her own home.

More particularly, a method of assisting an individual in preparing a tax return by a tax preparer is disclosed. The method may comprise the steps of receiving a scanned tax support document of the individual; establishing at least a one way video feed from the tax preparer to the individual; establishing two way voice communications between the tax preparer and the individual; inputting information into the tax return based on the scanned tax support document and questions answered by the individual; and transmitting the tax return inputted with information to the individual.

The establishing steps may comprise the steps of establishing a web based video conference between the tax preparer and the individual. The method may also further comprise the step of transmitting the inputted information to the individual as the information is being inputted so that the individual can view the tax return as the tax return is being completed by the tax preparer.

In another aspect, a method of assisting an individual in preparing a tax return by a tax preparer is disclosed. The method may comprise the steps of receiving a scanned tax support document of the individual; establishing a web based conference with the individual wherein the individual and the tax preparer can simultaneously view updated information inputted into an electronic copy of the tax return as the tax preparer inputs the information into the tax return; inputting information into the tax return based on the scanned tax support document and questions answered by the individual; and transmitting the tax return inputted with information to the individual.

The method may further comprise the step of establishing a two way voice communication between the individual and the tax preparer. Also, the establishing step may further comprise the step of establishing the web based conference with the individual wherein the individual and tax preparer can simultaneously view the scanned tax support documents and the tax return being prepared by the tax preparer.

In another aspect, a kiosk for assisting an individual in preparing a tax return by a tax preparer is disclosed. The kiosk may comprise a monitor, a speaker, a microphone, a scanner, a communication link and software. The monitor may be used for viewing one or more of a tax return, a tax support document of the individual and a video feed of the tax preparer. The speaker and microphone may be used for establishing two way voice communication between the individual and the tax preparer. The scanner may be used for electronically imaging tax support documents. The communication link may be used for providing visual and voice data to the individual. The software may be loaded on a processor capable of performing the step of viewing information inputted into the tax return as the tax preparer inputs the information. The monitory may also be a touch screen monitor. The communication link may be an internet connection.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a web based tax preparation system;

FIG. 2 is an illustration of a kiosk used in the web based tax preparation system shown in FIG. 1;

FIG. 3 is an illustration of a personal computer used in the web based tax preparation system shown in FIG. 1;

FIG. 4 is a flow chart of the steps of an individual in relation to the web based tax preparation system shown in FIG. 1; and

FIG. 5 is a flow chart of a tax preparer in relation to the web based tax preparation system shown in FIG. 1.

### DETAILED DESCRIPTION

Referring to the drawings, a web based tax preparation system 10a, b is shown. The system 10a, b allows an individual 12 to communicate with a tax preparer 14 through a kiosk system 10a or a personal computer 10b. To initiate the tax preparation session, the individual scans the individual's tax documents 100. The scanned tax documents 100 are displayable on a monitor 16 of the kiosk system 10a or the personal computer system 10b. The individual 12 confirms clarity of the scanned tax documents 102. Once the tax documents are scanned 100 and the clarity is confirmed 102, a web conference is established with the tax preparer 104. During the web conference, the tax preparer 14 may input tax information into a tax return of the individual 12 wherein the inputted tax information and the tax return are both simultaneously viewable by the individual 12 and tax preparer 14 in real time (i.e., as the tax preparer 14 inputs the tax information into the tax return). The individual 12 may view the inputted tax information and tax return on the monitor 16. The tax preparer 14 may also view the same information on his/her monitor. The individual 12 may confirm that the tax information is being inputted into the tax return by the tax preparer 14 in real time. Alternatively, the individual 12 may input his/her tax information into the tax return while the tax preparer 14 confirms that the appropriate tax information is being inputted into the tax return in real time.

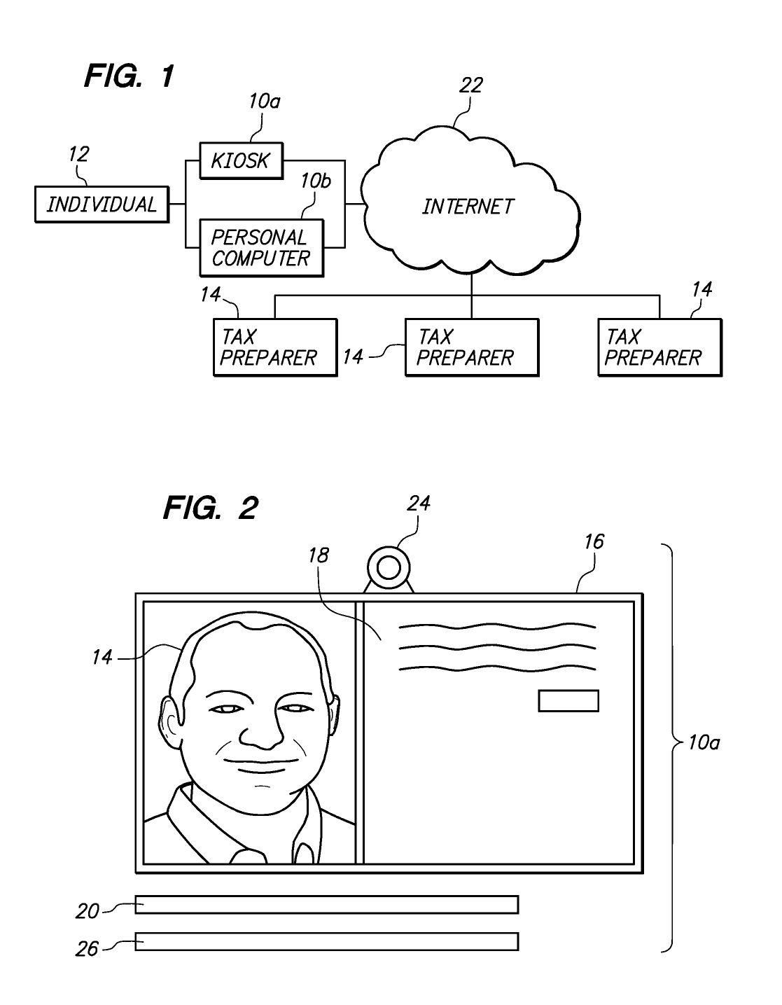

Referring now to FIG. 1, the individual 12 may utilize a kiosk 10a to have his/her tax return prepared by a tax preparer 14. The kiosk 10a may be located within a tax preparer's office or a store (e.g., supermarket, mall, etc.) where one or more kiosks 10a may be located. The individual 12 may approach any one of the kiosks 10a to have his/her tax return prepared by an offsite tax preparer 14. The kiosk 10a may be located in any location such as a non-tax preparation business (e.g., Ralph's, food store, mall, etc.). When the individual 12 approaches the kiosk 10a, the individual 12 views a monitor 16 (see FIG. 2) which may include a screen 18 that provides a series of prompts to guide the individual 12 in utilizing the kiosk 10a. The screen 18 may prompt the individual 12 to scan tax documents with the attached scanner 20. In doing so, the kiosk 10a may prompt the individual 12 to scan his/her W-2 Form, 1099 Form, charitable receipts, etc. After each tax document is scanned into the kiosk 10a by scanner 20, the scanned tax document is shown on the screen 18 which the individual 12 may inspect for clarity. The individual 12 confirms the clarity of the scanned documents with the kiosk 10a. By way of example and not limitation, the screen 18 may be a touch sensitive screen which may present a “clarity” confirmed button. The individual 12 may depress such button or may operate a mouse to depress the clarity confirmed button. For each tax document scanned into the kiosk 10a, the individual 12 may confirm its clarity after each tax document is scanned or at the end of the scanning process of all tax documents. For those scanned tax documents that are not clear, the kiosk 10a may request that the individual 12 rescan those specific tax documents.

The kiosk 10a may request that the individual 12 confirm that all tax documents have been scanned and their clarity confirmed. Upon doing so, the kiosk 10a may transmit the scanned tax documents to a tax preparer 14 or make those documents available to the tax preparer. Additionally, a web conference between the individual 12 and the tax preparer 14 may be established by way of a communication link (e.g., internet 22). The web conference may enable the individual 12 and the tax preparer 14 to view the same document (e.g., tax documents and tax return) at the same time even as it is being modified either by the tax preparer 14 or the individual 12. Additionally, the web conference enables the individual 12 and the tax preparer 14 to move a cursor to point out various items on the tax document and/or tax return to the other person. The web conference may also enable two-way voice communication between the individual 12 and the tax preparer 14. Alternatively, the two-way voice communication between the individual 12 and the tax preparer 14 may be established through other means such as cellular phone, landline, etc. It is also contemplated that the individual 12 may view a still electronic photo of the tax preparer 14 or a video feed of the tax preparer 14. The tax preparer 14 may also view a still electronic photo or a video feed of the individual 12 by way of camera 24. The electronic signal of the still photo or video feed may be transmitted to the tax preparer 14 through the communication link (e.g., internet 22).

Multiple kiosks 10a may be located at a particular location as well as throughout the city, state and country. Similarly, tax preparers may be located anywhere in the United States or the world. The tax preparer 14 may be an enrolled agent or a certified public accountant authorized to assist others in preparing tax returns. After the individual 12 scans and confirms the clarity of the scanned tax documents, the kiosk 10a may send a signal to a central processing system which routes the scanned and confirmed tax documents to an available tax preparer 14 or makes the tax documents available to the available tax preparer. A web conference between the individual 12 and the tax preparer 14 is established wherein the individual 12 may view a still photo or video feed of the tax preparer 14 as well as the scanned tax documents and tax return to be prepared. Simultaneously, the tax preparer 14 may also view a still photo or video feed of the individual 12 and the scanned and confirmed tax documents as well as a tax return of the individual. Once web conferencing is established, the individual 12 and the tax preparer 14 may communicate by way of voice, video, and have access to the same tax document and tax return in preparing the individual's 12 tax return. During the web conference, the tax preparer 14 may talk to the individual 12 regarding his/her tax documents and tax return. The tax preparer 14 may input tax information into the tax return. As the tax preparer 14 inputs the tax information into the tax return, the individual 12 may in real time or as the tax preparer 14 inputs the tax information, view the newly inputted tax information into the tax return. The individual 12 may view inputted tax information on the screen 18 of the kiosk 10a and may provide verbal confirmation to the tax preparer 14 or screen confirmation that the inputted tax information is correct by depressing a touch sensitive confirm button on the screen 18 or by operating a mouse which confirms the same.

Upon completion of the tax return, the completed tax return may be printed by the individual 12 by way of printer 26. The printed tax documents may be saved for the individual's 12 personal records. Additionally, the individual 12 may print out a second set of the tax return for mailing to the Federal and State governments. Alternatively, the tax preparer 14 may assist the individual 12 in e-filing his/her Federal and State tax returns. An electronic version of the completed tax return may be sent to the individual by way of email, etc.

In the event that the tax preparer 14 is unable to complete processing of the tax return of the individual 12 due to missing tax documents from the individual 12, the tax preparer 14 may provide the individual 12 with the opportunity to set up a username and password with the system so that the individual 12 may return with the appropriate tax documents in hand to complete processing of the tax return. Upon return by the individual 12 with the appropriate tax documents, the individual 12 may enter his/her username and password into the kiosk 10 to reinitiate the preparation of the tax return process. The kiosk 10a may recognize the individual 12 by way of the username and password. The kiosk 10a may request that the individual 12 scan the missing documents and confirm its clarity. Upon the scanning and confirmation, the kiosk 10a may send a signal to a central processing system which reroutes the scanned and confirmed tax documents to an available tax preparer 14. Preferably, if the prior tax preparer 14 who assisted the individual 12 in preparing the incomplete tax return is available, the central processing system may route the additional scanned and confirmed tax documents to that tax preparer 14. Otherwise, the central processing system may establish a connection between the individual 12 and the next available tax preparer 14.

The individual 12 may alternatively reconnect with the tax preparer 14 with his/her personal computer 10b. The individual 12 may establish a web connection and go to a designated website (e.g., www.trxfinancial.com) wherein the individual 12 may log in with his/her username and password. Once logged in, the individual 12 will scan the appropriate tax document with scanner 20, confirm clarity of the scanned documents. Upon scanning and confirming clarity of the scanned documents, the scanned and confirmed tax documents may be made available to an available tax preparer 14, preferably the prior tax preparer 14 that originally assisted the individual 12. A web conference may also be established between the individual 12 and the tax preparer 14. Upon completion of the tax return, the individual 12 may print out a copy of the completed tax return by way of printer 26. The completed tax return may be mailed to the Federal and State government. An additional set may also be printed out by printer 26 for the individual's 12 records. The tax preparer 14 may also assist the individual 12 in e-filing his/her Federal and State tax returns.

During the web conference, the individual 12 may ask the tax preparer 14 specific questions and general questions related to tax issues. Additionally, the tax preparer 14 may ask the individual 12 about specific clarifying questions regarding the tax documents of the individual 12.

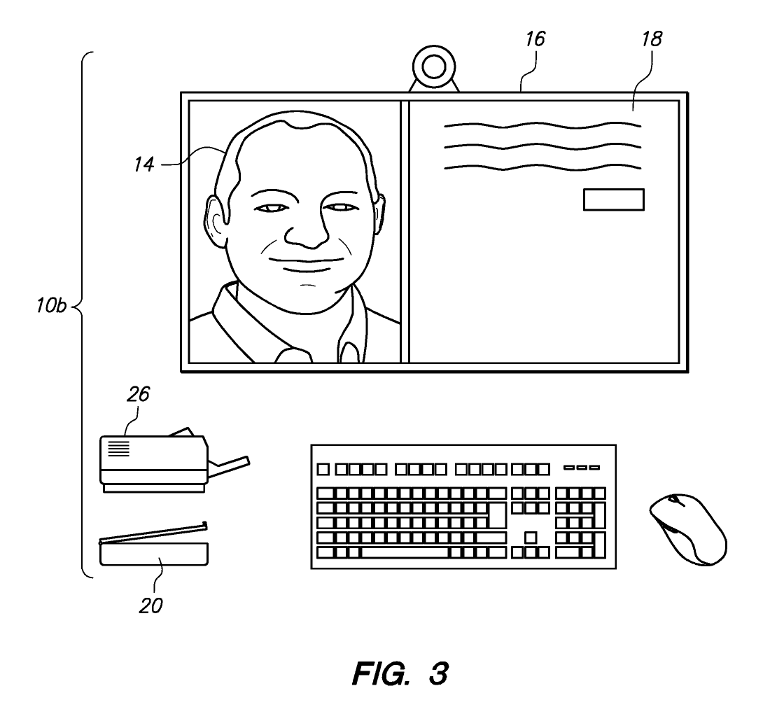

Referring now to FIG. 3, instead of utilizing a kiosk 10a, the individual may have his/her tax return prepared in the comfort his/her own home. To this end, the individual 12 may go to a particular website such as www.trxfinancial.com wherein the individual 12 may set up a particular username and password. The website may direct the individual 12 to scan all available tax documents and label each scanned tax document. By way of example and not limitation, the website may provide a pull down menu that provides the individual with a choice of labeling each tax document as appropriate (e.g., W-2, 1099-INT, 1099-DIV, charitable receipts, etc.). This feature may also be incorporated into the kiosk embodiment. The individual 12 scans the tax document with his/her home scanner 26. After each tax document is scanned, the individual 12 may confirm clarity of the scanned tax documents. Alternatively, the individual 12 may confirm clarity of the scanned tax documents after all of the tax documents have been scanned. After the individual 12 has scanned and confirmed all of his/her tax documents, the individual 12 may be connected to an available tax preparer 14 of a plurality of tax preparers 14 by way of communication link (e.g., internet 22). The pool of tax preparers 14 may be located anywhere in the United States and/or the world. The web conferencing may allow one or two-way photo and video feed viewing of the individual 12 and tax preparer 14. Additionally, the web conferencing may allow the individual 12 and the tax preparer 14 to view the same scanned tax documents and tax return. During the web conference, the tax preparer 14 may input the individual's 12 tax information into the tax return. As the tax preparer 14 inputs the individual's 12 tax information into the tax return, the individual 12 may view the tax return as it is being completed by the tax preparer 14. The individual 12 may confirm that the correct tax information is being inputted into the tax return by the tax preparer 14 in real time. In other words, as the tax preparer 14 inputs the tax information into the tax return, the inputted tax information is being updated onto the individual's 12 computer screen 18.

If the tax preparer 14 is unable to complete preparation of the tax return due to unavailable tax documents of the individual 12, the individual 12 and the tax preparer 14 may stop the web conferencing to allow the individual 12 to gather the appropriate tax documents, scan the appropriate tax documents and confirm its clarity before continuing on with the web conferencing. The individual 12 may return at a later time and date with the appropriate tax document. The individual 12 may scan the missing tax document with scanner 20 after logging into the website. After the missing tax documents have been scanned and its clarity confirmed, the individual 12 may be connected with the next available tax preparer 14. If the original tax preparer 14 is available, the individual 12 may be reconnected with that original tax preparer 14. Upon completion of the tax return, the individual 12 may print out a hard copy of the tax return with printer 26. Furthermore, the individual 12 may print out a second set of the completed tax return for mailing to the Federal and State government. Additionally, in the alternative, the tax preparer 14 may assist the individual 12 in e-filing.

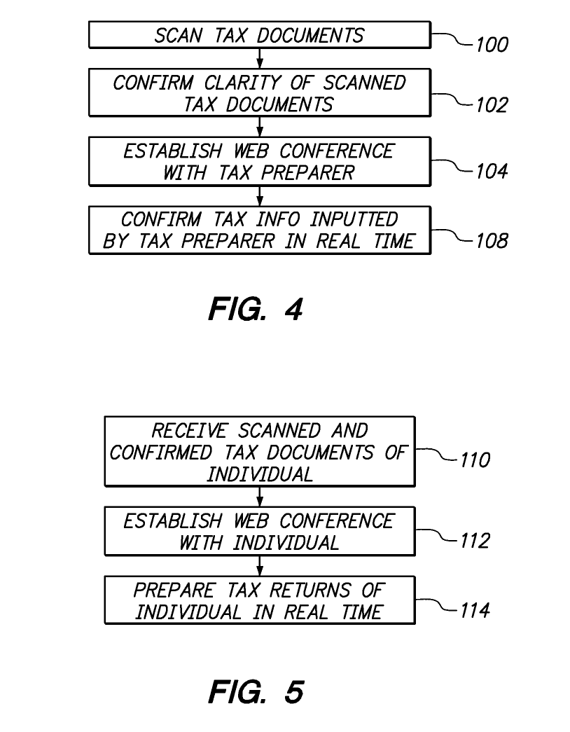

Referring now to FIGS. 4 and 5, method steps with respect to the individual 12 and the tax preparer 14 are shown. With respect to the individual 12, the individual 12 scans 100 tax documents. After scanning the tax documents, the individual 12 confirms 102 clarity of the scanned tax documents. Once the tax documents are scanned and its clarity confirmed, the web conference may be established 104 between the tax preparer 14 and the individual 12. During the web conference, the tax preparer 14 may input tax information into the tax return of the individual 12 which are both viewable by the tax preparer 14 and the individual 12 at the same time. The individual 12 may confirm 108 that the tax information inputted by the tax preparer 14 is correct as the tax preparer 14 is inputting the tax information into the tax return.

With respect to the tax preparer 14, the tax preparer 14 may be one of many tax preparers within a pool of tax preparers that are available to assist individuals 12 in preparing their tax returns. When the tax preparer 14 is available, a web conference may be established 112 between the individual 12 and the tax preparer 14. The tax preparer 14 has access to or receives the scanned and confirmed tax documents of the individual 12. The tax preparer 14 may input tax information of the individual 12 into the individual's tax return until completed.

In relation to the system disclosed herein, the scanning and verifying its clarity of the supporting tax documents may be an optional step. The individual may be immediately connected to the tax preparer when the individual starts the kiosk or logs onto the online website.

The system disclosed herein was discussed in relation to tax preparation. However, the system may also be used to facilitate transactions such as securing insurance, bill pay, money transfer, and immigration, travel and prepaid cards. In each of these other applications, the individual may scan supporting documents or input basic information necessary to the transaction before being connected (e.g., web conference) to a live customer service representative, insurance agent, travel agent, etc. After the supporting documents or basic necessary information is scanned, inputted or otherwise inputted into the kiosk or online website, the individual may be connected (e.g., web conference) to the next available customer service representative, insurance agent, travel agent, etc. to complete the transaction. Alternatively, the individual may be immediately connected (e.g., web conference) to the customer service representative, insurance agent, travel agent, etc. who can assist the individual in gathering the correct supporting documentation or inputting the correct basic information to complete the intended transaction.

The above description is given by way of example, and not limitation. Given the above disclosure, one skilled in the art could devise variations that are within the scope and spirit of the invention disclosed herein, including various ways of establishing a web conference between the individual and the tax preparer. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of assisting an individual in preparing a tax return by a tax preparer, the method comprising the steps of:
receiving a scanned tax support document of the individual;
establishing at least a one way video feed from the tax preparer to the individual;
establishing two way voice communications between the tax preparer and the individual;
inputting information into the tax return based on the scanned tax support document and questions answered by the individual; and
transmitting the tax return inputted with information to the individual.

2. The method of claim 1 wherein the establishing steps comprise the steps of establishing a web based video conference between the tax preparer and the individual.

3. The method of claim 1 further comprising the step of transmitting the inputted information to the individual as the information is being inputted so that the individual can view the tax return as the tax return is being completed by the tax preparer.

4. A method of assisting an individual in preparing a tax return by a tax preparer, the method comprising the steps of:
receiving a scanned tax support document of the individual;
establishing a web based conference with the individual wherein the individual and the tax preparer can simultaneously view updated information inputted into an electronic copy of the tax return as the tax preparer inputs the information into the tax return;
inputting information into the tax return based on the scanned tax support document and questions answered by the individual; and
transmitting the tax return inputted with information to the individual.

5. The method of claim 4 further comprising the step of establishing a two way voice communication between the individual and the tax preparer.

6. The method of claim 4 wherein the establishing step further comprising the step of establishing the web based conference with the individual wherein the individual and tax preparer can simultaneously view the scanned tax support documents and the tax return being prepared by the tax preparer.

7. A kiosk for assisting an individual in preparing a tax return by a tax preparer, the kiosk comprising:
a monitor for viewing one or more of a tax return, a tax support document of the individual and a video feed of the tax preparer;
a speaker and a microphone for establishing two way voice communication between the individual and the tax preparer;
a scanner for electronically imaging tax support documents;
a communication link for providing visual and voice data to the individual;
software loaded on a processor capable of performing the following step:
viewing information inputted into the tax return as the tax preparer inputs the information.

8. The kiosk of claim 7 wherein the monitor is a touch screen monitor.

9. The kiosk of claim 7 wherein the communication link is an internet connection.
